(19) United States
(12) Patent Application Publication
(10) Pub. No.: US 2026/0159693 A1
(43) Pub. Date: Jun. 11, 2026

(54) REVERSIBLY THERMOCHROMIC MICROCAPSULE PIGMENT

(71) Applicants: KABUSHIKI KAISHA PILOT CORPORATION (also trading as PILOT CORPORATION), Tokyo-to (JP); THE PILOT INK CO., LTD., Aichi-ken (JP)

(72) Inventor: Katsuyuki FUJITA, Aichi-ken (JP)

(21) Appl. No.: 18/706,195

(22) PCT Filed: Nov. 14, 2022
(86) PCT No.: PCT/JP2022/042197

§ 371 Date: Apr. 30, 2024

(30) Foreign Application Priority Data
Nov. 30, 2021 (JP) 2021-193781

(51) Int. Cl. C09B 57/00; C09B 67/08

(52) U.S. Cl. CPC C09B 57/00; C09B 67/0004

(57) ABSTRACT

A reversibly thermochromic microcapsule pigment according to the present invention has a reversible thermochromic composition encapsulated in microcapsules, the reversibly thermochromic composition consisting of a compound such as
(A) an electron-donating color-developing organic compound,
(B) a 4-hydroxybenzoic acid ester compound represented by General Formula (1) below as an electron-accepting compound,
(C) a compound such as a chain hydrocarbon as a reaction medium that reversibly induces an electron transfer reaction by the (A) and (B),
(D) a linear dibasic acid compound having 3 to 22 carbon atoms, and
(E) an aromatic hydrocarbon having a melting point of 50° C. or higher,

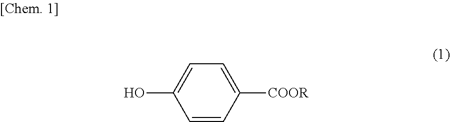

wherein R represents a linear or branched chain alkyl group having 12 to 22 carbon atoms.

### TECHNICAL FIELD

The present invention relates to a reversibly thermochromic microcapsule pigment. More specifically, the present invention relates to a reversibly thermochromic microcapsule pigment which develops color by being heated from a decolored state.

### BACKGROUND ART

Conventionally, among reversibly thermochromic compositions including (A) an electron-donating color-developing organic compound, (B) an electron-accepting compound, and (C) a reaction medium that reversibly induces an electron transfer reaction according to the above (A) and (B), a reversibly thermochromic composition that exhibits a discoloration behavior of easily being brought into a color developed state by being heated from a decolored state at a temperature in a daily life environmental temperature range or in the vicinity of a daily life temperature and returning to the decolored state by cooling by using a hydroxybenzoic acid ester as the component (B), and a microcapsule pigment containing the reversibly thermochromic composition have been disclosed (see, for example, Patent Literature 1 to Patent Literature 4).

Although the reversibly thermochromic composition shows a color developed state by heating at a relatively low temperature, it sometimes takes time to return to a decolored state, and it has been difficult to have sufficient practicality.

### CITATION LIST

### Patent Literature

Patent Literature 1: JP 2013-159706 A
Patent Literature 2: JP 2013-231138 A
Patent Literature 3: JP 2017-14328 A
Patent Literature 4: WO 2020/196073 A

### SUMMARY OF THE INVENTION

### Object of the Invention

As a result of intensive studies on a reversibly thermochromic composition that develops color by heating from a decolored state, the present inventors have found that by adding a specific compound in addition to components (A), (B), and (C), a reversibly thermochromic microcapsule pigment containing a reversibly thermochromic composition exhibiting a discoloration behavior that easily turns into a color developed state by heating from a decolored state at a temperature in a daily life environmental temperature range or a temperature in the vicinity of a daily life temperature and rapidly returns to the decolored state again is obtained, and have completed the present invention.

### Solution to Problem

According to the present invention, the following invention is provided. [1]A reversibly thermochromic microcapsule pigment in which a reversibly thermochromic composition that turns into a color developed state by heating from a decolored state and turns into a decolored state by lowering a temperature from a color developed state is encapsulated in a microcapsule, the pigment containing
(A) an electron-donating color-developing organic compound,
(B) a 4-hydroxybenzoic acid ester compound represented by General Formula (1) below as an electron-accepting compound,
(C) a compound selected from the group consisting of chain hydrocarbons, alicyclic hydrocarbons, and halogenated hydrocarbons as a reaction medium that reversibly induces an electron transfer reaction according to (A) and (B),
(D) a linear dibasic acid compound having 3 to 22 carbon atoms, and (E) a compound selected from the group consisting of alcohols, esters, ethers, ketones, acid amides, and aromatic hydrocarbons having a melting point of 50° C. or higher,

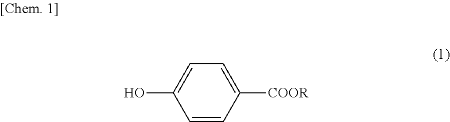

wherein R represents a linear or branched chain alkyl group having 12 to 22 carbon atoms.

[2] The reversibly thermochromic microcapsule pigment according to [1], in which the alkyl group of the hydroxybenzoic acid ester compound represented by General Formula (1) above is a linear chain alkyl group having 14 to 22 carbon atoms.

[3] The reversibly thermochromic microcapsule pigment according to [1] or

[2], in which a ratio of the component (D) to the component (A) is 0.1 to 1% by mass.

[4] The reversibly thermochromic microcapsule pigment according to any one of [1] to [3], in which a ratio of the component (F) to the component (A) is 0.3 to 2% by mass.

[5] The reversibly thermochromic microcapsule pigment according to any one of [1] to [4], further containing (F) an oligomer selected from a styrene-based oligomer having a weight average molecular weight of 200 to 6000, a terpene-based oligomer having a weight average molecular weight of 250 to 4000, or a terpene phenol-based oligomer having a weight average molecular weight of 200 to 2000.

[6] The reversibly thermochromic microcapsule pigment according to [5], in which a mass ratio of the component (D) to the component (F) is 1.0:3.5 to 1.0:30.0.

### Advantageous Effects of the Invention

The present invention can provide a reversibly thermochromic microcapsule pigment which exhibits a reversible discoloration behavior of easily turning into a color developed state by heating from a decolored state at a temperature in a daily life environmental temperature range or in the vicinity of a daily life temperature and rapidly returning to the decolored state again, and is applicable to various fields such as training elements, toys, and decorations.

### BEST MODE FOR CARRYING OUT THE INVENTION

The present invention relates to a reversibly thermochromic microcapsule pigment containing a reversibly thermochromic composition in microcapsules. First, the components contained in the reversibly thermochromic composition will be described as follows.

### Component (A)

The reversibly thermochromic composition used in the present invention contains an electron-donating color-developing organic compound (hereinafter, the component may be referred to as the component (A)). The component (A) is a component that determines color, and is a compound that donates electrons to an electron-accepting compound that is a developer to develop color.

Examples of the component (A) include phthalide compounds, fluoran compounds, stylinoquinoline compounds, diazarhodamine lactone compounds, pyridine compounds, quinazoline compounds, and bisquinazoline compounds, among which phthalide compounds and fluoran compounds are preferable.

Examples of the phthalide compound include diphenylmethane phthalide compounds, phenylindolyl phthalide compounds, indolyl phthalide compounds, diphenylmethane azaphthalide compounds, phenylindolyl azaphthalide compounds, and derivatives thereof, among which phenylindolyl azaphthalide compounds and derivatives thereof are preferable.

In addition, examples of the fluoran compound include aminofluoran compounds, alkoxyfluoran compounds, and derivatives thereof.

These compounds are exemplified below.

Examples thereof include 3,3-bis(p-dimethylaminophenyl)-6-dimethylaminophthalide,
3-(4-diethylaminophenyl)-3-(1-ethyl-2-methylindol-3-yl)phthalide,
3,3-bis(1-n-butyl-2-methylindol-3-yl)phthalide,
3,3-bis(2-ethoxy-4-diethylaminophenyl)-4-azaphthalide,
3-(2-ethoxy-4-diethylaminophenyl)-3-(1-ethyl-2-methylindol-3-yl)-4-azaphthalide,
3-(2-hexyloxy-4-diethylaminophenyl)-3-(1-ethyl-2-methylindol-3-yl)-4-azaphthalide,
3-[2-ethoxy-4-(N-ethylanilino)phenyl]-3-(1-ethyl-2-methylindol-3-yl)-4-azaphthalide,
3-(2-acetamido-4-diethylaminophenyl)-3-(1-propylindol-3-yl)-4-azaphthalide,
3,6-bis(diphenylamino)fluorane,
3,6-dimethoxyfluorane,
3,6-di-n-butoxyfluorane,
2-methyl-6-(N-ethyl-N-p-tolylamino)fluorane,
3-chloro-6-cyclohexylaminofluorane,
2-methyl-6-cyclohexylaminofluorane,
2-(2-chloroamino)-6-dibutylaminofluorane,
2-(2-chloroanilino)-6-di-n-butylaminofluorane,
2-(3-trifluoromethylanilino)-6-diethylaminofluorane,
2-(3-trifluorormethylanilino)-6-dipentylarninofluorane,
2-(dibenzylamino)-6-diethylaminofluorane,
2-(N-methylanilino)-6-(N-ethyl-N-p-tolylamino)fluorane,
1,3-dimethyl-6-diethylaminofluorane,
2-chloro-3-methyl-6-diethylaminofluorane,
2-anilino-3-methyl-6-diethylaminofluorane,
2-anilino-3-methoxy-6-diethylaminofluorane,
2-anilino-3-methyl-6-di-n-butylaminofluorane,
2-anilino-3-methoxy-6-di-n-butylaminofluorane,
2-xylidino-3-methyl-6-diethylaminofluorane,
2-anilino-3-methyl-6-(N-ethyl-N-p-tolylamino)fluorane,
1,2-benz-6-diethylaminofluorane,
1,2-benz-6-(N-ethyl-N-isobutylamino)fluorane,
1,2-benz-6-(N-ethyl-N-isoamylamino)fluorane,
2-(3-methoxy-4-dodecoxystyryl)quinoline,
spiro[5H-(1)benzopyrano(2,3-d)pyrimidine-5,1′(3′H)isobenzofuran]-3′-one, 2-(diethylamino)-8-(diethylamino)-4-methyl,
spiro[5H-(1)benzopyrano(2,3-d)pyrimidine-5,1′(3′H)isobenzofuran]-3′-one, 2-(di-n-butylamino)-8-(di-n-butylamino)-4-methyl,
spiro[5H-(1)benzopyrano(2,3-d)pyrimidine-5,1′(3′H)isobenzofuran]-3′-one, 2-(di-n-butylamino)-8-(diethylamino))-4-methyl,
spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl,
spiro[5H-(1)benzopyrano(2,3-d)pyrimidine-5,1′(3′H)isobenzofuran]-3′-one, 2-(dibutylamino)-8-(dipentylamino)-4-methyl,
spiro[5H-(1)benzopyrano(2,3-d)pyrimidine-5,1′(3′H)isobenzofuran]-3′-one, 2-(dibutylamino)-8-(diphenylamino)-4-methyl,
4,5,6,7-tetrachloro-3-[4-(dimethylamino)-2-methoxyphenyl]-3-(1-butyl-2-methyl-1H-indol-3-yl)-1(3H)-isobenzofuranone,
4,5,6,7-tetrachloro-3-[4-(diethylamino)-2-ethoxyphenyl]-3-(1-ethyl-2-methyl-1H-indol-3-yl)-1(3H)-isobenzofuranone,
4,5,6,7-tetrachloro-3-[4-(diethylamino)-2-ethoxyphenyl]-3-(1-pentyl-2-methyl-1H-indol-3-yl)-1(3H)-isobenzofuranone,
4,5,6,7-tetrachloro-3-[4-(diethylamino)-2-methylphenyl]-3-(1-ethyl-2-methyl-1H-indol-3-yl)-1(3H)-isobenzofuranone,
3′,6′-bis[phenyl(2-methylphenyl)amino]-spiro[isobenzofuran-1(3H),9′-[9H]xanthene]-3-one,
3′,6′-bis[phenyl(3-methylphenyl)amino]-spiro[isobenzofuran-1(3H),9′-[9H]xanthene]-3-one,
3′,6′-bis[phenyl(3-ethylphenyl)amino]-spiro[isobenzofuran-1(3H),9′-[9H]xanthene]-3-one,
2,6-bis(2′-ethyloxyphenyl)-4-(4′-dimethylaminophenyl)pyridine,
2,6-bis(2′,4′-diethyloxyphenyl)-4-(4′-dimethylaminophenyl)pyridine,
2-(4′-dimethylaminophenyl)-4-methoxy-quinazoline,
3,4′-(ethylenedioxy)-bis[2-(4-diethylaminophenyl)quinazoline], and the like.

The fluorans may be, in addition to the above-mentioned compounds having a substituent on a phenyl group forming a xanthene ring, compounds exhibiting blue or black having a substituent on a phenyl group forming a xanthene ring and also having a substituent (for example, an alkyl group such as a methyl group or a halogen atom such as a chloro group) on a phenyl group forming a lactone ring.

### Component (B)

The reversibly thermochromic composition used in the present invention contains an electron-accepting compound (hereinafter, the component may be referred to as the component (B)). The component (B) is a compound that receives electrons from the component (A) and functions as a developer of the component (A).

As the component (B), a hydroxybenzoic acid ester compound represented by General Formula (1) is used:

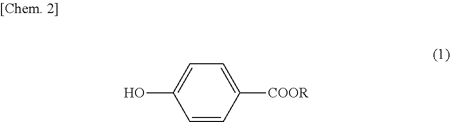

wherein R represents a linear or branched chain alkyl group having 12 to 22 carbon atoms.

The alkyl group R of the hydroxybenzoic acid ester is a linear or branched chain alkyl group having 12 to 22 carbon atoms. In a system having an alkyl group having less than 12 or more than 22 carbon atoms, the crystallization is low, and thus the practicality is not sufficient. In addition, a linear chain alkyl group having 14 to 22 carbon atoms is preferable in consideration of practical performance such as excellent discoloration characteristics and coloring density.

Examples of the hydroxybenzoic acid ester compound include dodecyl 4-hydroxybenzoate, tridecyl 4-hydroxybenzoate, tetradecyl 4-hydroxybenzoate, pentadecyl 4-hydroxybenzoate, hexadecyl 4-hydroxybenzoate, heptadecyl 4-hydroxybenzoate, octadecyl 4-hydroxybenzoate, nonadecyl 4-hydroxybenzoate, eicosyl 4-hydroxybenzoate, heneicosyl 4-hydroxybenzoate, and docosyl 4-hydroxybenzoate.

### Component (C)

The reversibly thermochromic composition used in the present invention includes a reaction medium (hereinafter, the component may be referred to as a component (C)) that reversibly causes an electron transfer reaction by the component (A) and the component (B). As the component (C), a compound selected from the group consisting of chain hydrocarbons, alicyclic hydrocarbons, and halogenated hydrocarbons is used.

By using the component (C), there is little desensitization to color development caused by the reaction between the component (A) and the component (B), and it functions effectively to improve the color change behavior and color density due to heating.

Incidentally, the hydroxybenzoic acid ester of the component (B) tends to have a higher crystallization as the number of carbon atoms of the alkyl group becomes larger, and the hydroxybenzoic acid ester having high crystallization can be used at a discoloration temperature in a low temperature range by the addition of the component (C).

Examples of the chain hydrocarbons include (i) saturated chain hydrocarbons such as pentadecane, hexadecane, heptadecane, octadecane, nonadecane, eicosane, heneicosane, docosane, tricosane, tetracosane, pentacosane, hexacosane, heptacosane, octacosane, nonacosane, and triacontane; and (ii) unsaturated chain hydrocarbons such as 1-pentadecene, 1-hexadecene, 1-heptadecene, 1-octadecene, 1-nonadecene, 1-eicosene, I-heneicosene, 1-docosene, 1-tricosene, 1-tetracosene, 1-pentacosene, 1-hexacosene, 1-heptacosene, 1-octacosene, 1-nonacosene, and 1-triaconene.

Examples of the alicyclic hydrocarbons include cyclooctane, cyclododecane, n-pentadecylcyclohexane, n-octadecylcyclohexane, n-nonadecylcyclohexane, decahydronaphthalene, and the like.

Examples of the halogenated hydrocarbons include 1-bromodecane, 1-bromoundecane, 1-bromododecane, 1-bromotridecane, 1-bromotetradecane, 1-chlorotetradecane, 1-bromopentadecane, 1-bromohexadecane, 1-chlorohexadecane, 1-iodohexadecane, 1-bromoheptadecane, 1-bromooctadecane, 1-chlorooctadecane, 1-iodooctadecane, 1-bromoeicosane, 1-chloroeicosane, 1-bromodocosane, 1-chlorodicosane, and the like.

### Component (D)

The reversibly thermochromic composition used in the present invention contains a linear dibasic acid compound having 3 to 22 carbon atoms (hereinafter, the component may be referred to as the component (D)). Examples of the component (D) include propanedioic acid, pentanedioic acid (glutaric acid), hexanedioic acid (adipic acid), heptanedioic acid (azelaic acid), octanedioic acid (suberic acid), nonanedioic acid (azelaic acid), decanedioic acid (sebacic acid), undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, eicosanedioic acid, and docosanedioic acid.

By adding the component (D), the polarity of a compound selected from chain hydrocarbons, alicyclic hydrocarbons, and halogenated hydrocarbons as a reaction medium changes, so that the solubility of the component (B) in the reaction medium decreases, and the crystallization of the component (B) gradually proceeds. Therefore, the reversibly thermochromic microcapsule pigment containing the reversibly thermochromic composition that has been cooled from a color developed state to a decoloring-inducing temperature in the temperature decreasing process rapidly decolors when left to stand.

### Component (E)

The reversibly thermochromic composition used in the present invention contains a compound (hereinafter, the component may be referred to as the component (E)) selected from the group consisting of alcohols, esters, ethers, ketones, acid amides, and aromatic hydrocarbons having a melting point of 50° C. or higher. In the reversibly thermochromic composition used in the present invention, the component (B) is crystallized and decolored by the component (D) in a temperature lowering process from a color developed state, but the component (E) further promotes crystallization such that decoloring can be more rapid.

Examples of the alcohols include hexadecan-1-ol, heptadecan-t-ol, octadecan-1-ol, nonadecan-1-ol, eicosan-1-ol, heneicosan-t-ol, docosane 1-ol, tetracosan-1-ol, hexacosan-1-ol, octacosan-1-ol, and triacontan-1-ol.

Examples of the esters include eicosyl laurate, behenyl laurate, tetracosyl laurate, hexacosyl laurate, octacosyl laurate, cetyl myristate, stearyl myristate, eicosyl myrisitate, behenyl myristate, tetracosyl myristate, hexacosyl myristate, octacosyl myristate, myristyl palmitate, cetyl palmitate, stearyl palmitate, eicosyl palmitate, behenyl palmitate, tetracosyl palmitate, hexacosyl palmitate, octacosyl palmitate, cetyl stearate, stearyl stearate, eicosyl stearate, behenyl stearate, tetracosyl stearate, hexacosyl stearate, octacosyl stearate, decyl eicosanoate, undecyl eicosanoate, tridecyl eicosanoate, myristyl eicoate, cetyl eicoate, stearyl eicoate, eicosyl eicoate, docosyl eicoate, tetracosyl eicoate, hexacosyl eicoate, octacosyl eicoate, methyl behenate, hexyl behenate, octyl behenate, decyl behenate, undecyl behenate, lauryl behenate, tridecyl behenate, myristyl behenate, cetyl behenate, stearyl behenate, eicosyl behenate, behenyl behenate, tetracosyl behenate, hexacosyl behenate, octacosyl behenate, distearyl oxalate, diacosyl oxalate, behenyl oxalate, distearyl succinate, eicosyl succinate, behenyl succinate, distearyl glutarate, dieicosyl glutarate, behenyl glutarate, dimyristyl adipate, dicetyl adipate, distearyl adipate, eicosyl adipate, behenyl adipate, dicetyl suberate, distearyl suberate, diacosyl suberate, behenyl suberate, myristyl azelate, dicetyl azelate, distearyl azelate, eicosyl azelate, behenyl azelate, dimyristyl sebacate, dicetyl sebacate, distearyl sebacate, dieicosyl sebacate, dibehenyl sebacate, ditridecyl 1,14-tetradecamethylenedicarboxylate, dimyristyl 1,14-tetradecamethylenedicarboxylate, dicetyl 1,14-tetradecamethylenedicarboxylate, dipalmityl 1,14-tetradecamethylenedicarboxylate, distearyl 1,14-tetradecamethylenedicarboxylate, dieicosyl 1,14-tetradecamethylenedicarboxylate, dibehenyl 1,14-tetradecamethylenedicarboxylate, dilauryl 1,16-hexadecamethylenedicarboxylate, ditridecyl 1,16-hexadecamethylenedicarboxylate, dimyristyl 1,16-hexadecamethylenedicarboxylate, dicetyl 1,16-hexadecamethylenedicarboxylate, dipalmityl 1,16-hexadecamethylenedicarboxylate, distearyl 1,16-hexadecamethylenedicarboxylate, dielcosyl 1,16-hexadecamethylene dicarboxylate, dibehenyl 1,16-hexadecamethylenedicarboxylate, didecyl 1,18-octadecamethylenedicarboxylate, dilauryl 1,18-octadecamethylenedicarboxylate, ditridecyl 1,18-octadecamethylenedicarboxylate, dimyristyl 1,18-octadecarmethylenedicarboxylate, dicetyl 1,18-octadecamethylenedicarboxylate, dipalmityl 1,18-octadecamethylenedicarboxylate, distearyl 1,18-octadecamethylenedicarboxylate, dieicosyl 1,18-octadecamethylenedicarboxylate, dibehenyl 1,18-octadecamethylenedicarboxylate, didecyl 1,20-eicosylmethylenedicarboxylate, dilauryl 1,20-eicosylmethylenedicarboxylate, ditridecyl 1,20-eicosylmethylenedicarboxylate, dimyristyl 1,20-eicosylmethylenedicarboxylate, dicetyl 1,20-eicosylmethylenedicarboxylate, dipalmityl 1,20-eicosylmethylenedicarboxylate, distearyl 1,20-eicosylmethylenedicarboxylate, dieicosyl 1,20-eicosylmnethylenedicarboxylate, dibehenyl 1,20-eicosylmethylenedicarboxylate, trimyristin, tripalmitin, tristearin, trinonadecanoin, cholesterol caproate, cholesterol caprylate, cholesterol caprate, cholesterol undecanoate, cholesterol laurate, cholesterol myristate, cholesterol palmitate, cholesterol stearate, eicosanoic acid cholesterol, cholesterol behenate, and the like.

Examples of the ethers include pentadecyl ether, dihexadecyl ether, dioctadecyl ether, dieicosyl ether, didocosyl ether, and the like.

Examples of the ketones include dioctyl ketone, dinonyl ketone, diundecyl ketone, ditridecyl ketone, dipentadecyl ketone, diheptadecyl ketone, dinonadecyl ketone, phenyloctyl ketone, phenylundecyl ketone, phenyltridecyl ketone, phenylpentadecyl ketone, phenylheptadecyl ketone, and the like.

Examples of the acid amides include hexylamide, heptylamide, octylamide, nonylamide, decylamide, undecylamide, laurylamide, tridecylamide, myristylamide, palmitylamide, stearylamide, eicosylamide, behenylamide, hexacosylamide, octacosylamide, and the like.

Examples of the aromatic hydrocarbons include dodecylbenzene, biphenyl, ethylbiphenyl, 4-benzylbenzene, phenyltolylmethane, diphenylethane, 1,3-diphenylbenzene, dibenzyltoluene, methylnaphthalene, 2,7-diisopropyinaphthalene, methyltetralin, naphthylphenylmethane, and the like.

### Component (F)

The reversibly thermochromic composition according to the present invention contains the components (A), (B), (C), (D) and (E), and can further contain an oligomer (hereinafter, sometimes referred to as component (F)) selected from a styrene-based oligomer having a weight average molecular weight of 200 to 6000, a terpene-based oligomer having a weight average molecular weight of 250 to 4000, and a terpene phenol-based oligomer having a weight average molecular weight of 200 to 2000.

When the reversibly thermochromic composition according to the present invention contains the component (F), the polarity of the component (C) changes, and the solubility of the component (B) in the reaction medium containing the component (F) decreases, whereby the crystallization of the component (B) itself further proceeds. As a result, the reversibly thermochromic microcapsule pigment containing the reversibly thermochromic composition that has been cooled to a decoloring induction temperature in a temperature decreasing process from a color developed state is more likely to be decolored more rapidly when left standing. That is, the component (F) has an effect of increasing the effect of the component (D).

In a case where the weight average molecular weight of the styrene-based oligomer is less than 200, the solubility of the component (B) in a reaction medium is unlikely to decrease, and the crystallization of the component (B) itself tends to be unlikely to proceed. In addition, when the weight average molecular weight of the styrene-based oligomer is more than 6000, it is difficult to dissolve the component (F) in the component (C), and a desired effect is easily obtained.

In addition, in a case where the weight average molecular weight of the terpene-based oligomer is less than 2500, the solubility of the component (B) in a reaction medium is unlikely to decrease, and the crystallization of the component (B) itself tends to be unlikely to proceed. In addition, when the weight average molecular weight of the terpene-based oligomer is more than 4000, it is difficult to dissolve the component (F) in the component (C), and a desired effect is easily obtained.

In addition, in a case where the weight average molecular weight of the terpene phenol-based oligomer is less than 200, the solubility of the component (B) in a reaction medium is unlikely to decrease, and the crystallization of the component (B) itself tends to be unlikely to proceed. In addition, when the weight average molecular weight of the terpene phenol-based oligomer is more than 2000, it is difficult to dissolve the component (F) in the component (C), and a desired effect is easily obtained.

The weight average molecular weight is measured by a GPC method (gel permeation chromatography).

Examples of the styrene-based oligomer include low molecular weight polystyrene, a styrene-α-methylstyrene copolymer, an α-methylstyrene polymer, a copolymer of α-methylstyrene and vinyltoluene, and the like.

As the low molecular weight polystyrene, Hymer SB-75 (weight average molecular weight: 2000), Hymer ST-95 (weight average molecular weight 4000) (trade name) manufactured by Sanyo Chemical Industries, Ltd., and the like are used.

As the styrene-a-methylstyrene copolymer, Piccolastic A5 (weight average molecular weight: 317), Piccolastic A75 (weight average molecular weight: 917) (trade name) manufactured by Rika Hercules Co., Ltd. and the like are used.

As the a-methylstyrene polymer, Kristalex 3085 (weight average molecular weight: 664), Kristalex 3100 (weight average molecular weight: 1020), Kristalex 1120 (weight average molecular weight: 2420) and the like (trade name) manufactured by Rika Hercules Co., Ltd. are used.

As the copolymer of α-methylstyrene and vinyltoluene, Piccotex LC (weight average molecular weight: 950), Piccotex 100 (weight average molecular weight: 1740), Piccotex 120 (weight average molecular weight: 2500) (trade name) manufactured by Rika Hercules Co., Ltd. and the like are used.

Examples of the terpene-based oligomer include an α-pinene polymer, a β-pinene polymer, and a d-limonene polymer.

As the α-pinene polymer, Piccolyte A115 (weight average molecular weight: 833) (trade name) manufactured by Rika Hercules Co., Ltd. is used.

As the β-pinene polymer, Piccolyte S115 (weight average molecular weight: 1710) (trade name) manufactured by Rika Hercules Co., Ltd. is used.

As the d-limonene polymer, Piccolyte C115 (weight average molecular weight: 902) (trade name) manufactured by Rika Hercules Co., Ltd. is used.

The terpene phenol-based oligomer is a compound obtained by copolymerizing a cyclic terpene monomer and a phenol or a hydrogenated product thereof, and specific examples thereof include an α-pinene-phenol copolymer.

As the α-pinene-phenol copolymer, YS POLYSTER T145 (weight average molecular weight: 1050), YS POLYSTER T130 (weight average molecular weight: 900), YS POLYSTER T500 (weight average molecular weight: 500), and YS POLYSTER S145 (weight average molecular weight: 1050) (trade name) manufactured by Yasuhara Chemical Co., Ltd. and the like are used.

The components (F) may be used alone, or two or more kinds thereof may be used in combination.

The reversibly thermochromic microcapsule pigment according to the present invention contains a reversibly thermochromic composition. This reversibly thermochromic composition contains components (A), (B), (C), (D), and (E). As one embodiment, the reversibly thermochromic composition includes the components (A), (B), (C), (D), and (E). In addition, in another embodiment, the reversibly thermochromic composition contains components (A), (B), (C), (D), (E), and (F).

The proportion of each of the components (A), (B), (C), (D), and (E) depends on the color density, discoloration temperature, discoloration form, and type of each component, but in general, the component ratio at which desired characteristics are obtained is in the range of 0.1 to 50 parts by mass, preferably 0.5 to 20 parts by mass of the component (B), 1 to 200 parts by mass, preferably 5 to 100 parts by mass of the component (C), 0.1 to 1.0 parts by mass, preferably 0.3 to 0.7 parts by mass of the component (D), 0.3 to 2 parts by mass, and preferably 0.5 to 1.5 parts by mass of the component (E), with respect to 1 part by mass of the component (A).

In addition, in a case where the component (F) is blended, the blending amount of the component (F) is generally in the range of 3.0 to 15 parts by mass, and preferably 3 to 10 parts by mass, based on 1 part by mass of the component (A).

In addition, when the mass ratio of the component (D) to the component (F) is, for example, 1.0:3.5 to 1.0:30.0, preferably 1.0:3.5 to 1.0:20.0, and more preferably 1.0:3.5 to 1.0:15.0, the polarity change of the compound as a reaction medium and the crystallization of the component (B) more easily proceed, and decoloring occurs more rapidly.

The reversibly thermochromic composition is used by being encapsulated in microcapsules. This is because, of course, even when the reversibly thermochromic composition is brought into contact with a chemically active substance such as an acidic substance, a basic substance, or a peroxide, or another solvent component, the function thereof is not deteriorated, and the heat-resistant stability can be maintained, and the reversibly thermochromic composition is maintained at the same composition under various use conditions, and the same action and effect can be exhibited.

The reversibly thermochromic microcapsule pigment encapsulating the reversibly thermochromic composition has a particle diameter of 0.1 to 100 μm, preferably 0.5 to 30 μm, more preferably 1 to 20 μm, which satisfies practicality.

The particle size and the average particle size are measured as the particle size and the average particle size of the particles equivalent to an equal volume sphere based on the values obtained by determining the region of the particles using image analysis type particle size distribution measurement software “MACK VIEW” manufactured by Mountech Co., Ltd., calculating the equivalent circle diameter (Heywood diameter) of the projected area from the area of the region of the particles, and measuring. In addition, in a case where the particle diameter of all or most of the particles exceeds 0.2 μm, it is also possible to measure the particle diameter and the average particle diameter of particles equivalent to an equal volume sphere by a Coulter method using a particle size distribution measuring apparatus (product name: Multisizer 4e, manufactured by Beckman Coulter, Inc.).

Further, the volume-based particle size and the average particle size (median diameter) may be measured using a laser diffraction/scattering particle size distribution measuring apparatus (device name: LA-960V2, manufactured by HORIBA, Ltd.) calibrated based on a numerical value measured using a measuring device by the Coulter method.

Each component may be a mixture of two or more compounds, and further, a light stabilizer can be added as long as the function is not hindered.

Examples of the light stabilizer include compounds that suppress oxidation reaction, such as ultraviolet absorbers that prevent photodegradation caused by an excited state due to photoreaction of the component (A), visible light absorbers, infrared absorbers, antioxidants, singlet oxygen quenchers such as carotenes, dyes, amines, phenols, nickel complexes, and sulfides, superoxide anion quenchers such as complexes of oxide dismutase with cobalt and nickel, and ozone quenchers. The light stabilizer is blended in an amount of 0.3 to 24 mass %, preferably 0.8 to 16 mass %. Among them, a system using the ultraviolet absorber in combination with an antioxidant and/or a singlet oxygen quencher is particularly effective in improving light resistance.

In addition, an antiaging agent, an antistatic agent, a polarity imparting agent, a thixotropy imparting agent, an antifoaming agent, and the like can be added as necessary to improve the function.

Furthermore, a general dye pigment (non-thermochromic) can also be blended.

Examples of the general dye pigment include an acidic dye, a basic dye, a direct dye, an inorganic pigment, an organic pigment, a colored resin pigment, and titanium dioxide.

The discoloration characteristics of a reversibly thermochromic microcapsule pigment encapsulating a reversibly thermochromic composition comprising the components (A), (B), (C), (D) and (E) or a reversibly thermochromic composition comprising the components (A), (B), (C), (D), (E) and (F) will be described.

The reversibly thermochromic composition exhibiting a color decolored state starts to develop color from the color development starting temperature (T₁) in the heating process, and when the temperature reaches the complete color development temperature (T₂), the reversibly thermochrormic composition becomes in a complete color developed state, and the reversibly thermochromic composition cooled to the decoloring induction temperature in the cooling process is decolored when left to stand.

The reversibly thermochromic microcapsule pigment is dispersed in a medium containing a binder which is a film-forming material, and applied as a reversibly thermochromic material such as an ink or a paint, and a reversibly thermochromic layer can be formed on a support such as paper, synthetic paper, fabric, flocked or napped fabric, nonwoven fabric, synthetic leather, leather, plastic, glass, ceramics, wood, stone, or the like or dispersed in the support by a conventionally known method, for example, printing means such as screen printing, offset printing, gravure printing, coater, tampo-printing, inkjet printing, or transfer, brush coating, spray coating, electrostatic coating, electrodeposition coating, flow coating, roller coating, dip coating, or the like.

Furthermore, it can be applied as an integrated material by being kneaded into a thermoplastic plastic in a molten state.

### EXAMPLES

### Examples 1 to 20

The composition used in the reversibly thermochromic composition of the present invention is shown in the following table.

The numbers in ( ) in the table indicate parts by mass, and the numbers indicating the blending amounts shown below are all parts by mass.

TABLE 1

| | | | | | | |
|---|---|---|---|---|---|---|
| Example | (A) | (B) | (C) | (D) | (E) | (F) |

| | | | | | |
|---|---|---|---|---|---|
| 1 | 3′6′-Bis[Phenyl (3-Methylphenyl) | Cetyl 4- | Pentadecane | Suberic acid | P- |
| | Amino]-Spiro [isobensofuran-1(3H),9′- | hydroxybenzoate | (30.0) | (0.5) | terphenyl |
| | [9H]xanthene]-3-on | (10.0) | | | (1.0) |
| | (1.0) | | | | |
| 2 | 3′6′-Bis[Phenyl (3-Methylphenyl) | Stearyl 4- | Pentadecane | Glutaric acid | P- |
| | Amino]-Spiro [isobensofuran-1(3H),9′- | hydroxybenzoate | (30.0) | (0.5) | terphenyl |
| | [9H]xanthene]-3-on | (10.0) | | | (1.0) |
| | (1.0) | | | | |
| 3 | 3′6′-Bis[Phenyl (3-Methylphenyl) | Stearyl 4- | Pentadecane | Suberic acid | P- |
| | Amino]-Spiro [isobensofuran-1(3H),9′- | hydroxybenzoate | (30.0) | (0.5) | terphenyl |
| | [9H]xanthene]-3-on | (10.0) | | | (1.0) |
| | (1.0) | | | | |
| 4 | 3′6′-Bis[Phenyl (3-Methylphenyl) | Stearyl 4- | Pentadecane | Suberic acid | P- |
| | Amino]-Spiro [isobensofuran-1(3H),9′- | hydroxybenzoate | (30.0) | (1.0) | terphenyl |
| | [9H]xanthene]-3-on | (10.0) | | | (1.0) |
| | (1.0) | | | | |
| 5 | 3′6′-Bis[Phenyl (3-Methylphenyl) | Stearyl 4- | Pentadecane | Azelaic acid | P- |
| | Amino]-Spiro [isobensofuran-1(3H),9′- | hydroxybenzoate | (30.0) | (0.5) | terphenyl |
| | [9H]xanthene]-3-on | (10.0) | | | (1.0) |
| | (1.0) | | | | |
| 6 | 3′6′-Bis[Phenyl (3-Methylphenyl) | Stearyl 4- | Pentadecane | Sebacic acid | P- |
| | Amino]-Spiro [isobensofuran-1(3H),9′- | hydroxybenzoate | (30.0) | (0.5) | terphenyl |
| | [9H]xanthene]-3-on (1.0) | (10.0) | | | (1.0) |
| 7 | 2-(dibutylamino)-8-(diphenylamino)-4- | Stearyl 4- | Pentadecane | Sebacic acid | P- |
| | methylspiro[5H-[1]benzopyrano[2,3- | hydroxybenzoate | (30.0) | (1.0) | terphenyl |
| | d]pyrimidine-5,1′(3′H)-isobenzofuran]- | (10.0) | | | (1.0) |
| | 3′-on | | | | |
| | (1.0) | | | | |
| 8 | 3′6′-Bis[Phenyl (3-Methylphenyl) | Stearyl 4- | Pentadecane | Dodecanedioic | P- |
| | Amino]-Spiro [isobensofuran-1(3H),9′- | hydroxybenzoate | (30.0) | acid | terphenyl |
| | [9H]xanthene]-3-on | (10.0) | | (0.5) | (1.0) |
| | (1.0) | | | | |
| 9 | 3′6′-Bis[Phenyl (3-Methylphenyl) | Stearyl 4- | Pentadecane | Eicosanedioic | P- |
| | Amino]-Spiro [isobensofuran-1(3H),9′- | hydroxybenzoate | (30.0) | acid | terphenyl |
| | [9H]xanthene]-3-on | (10.0) | | (0.5) | (1.0) |
| | (1.0) | | | | |
| 10 | 3′6′-Bis[Phenyl (3-Methylphenyl) | Arachidyl 4- | Pentadecane | Suberic acid | P- |
| | Amino]-Spiro [isobensofuran-1(3H),9′- | hydroxybenzoate | (30.0) | (0.5) | terphenyl |
| | [9H]xanthene]-3-on | (10.0) | | | (1.0) |
| | (1.0) | | | | |

TABLE 2

| Example | (A) | (B) | (C) | (D) | (E) | (F) |
|---|---|---|---|---|---|---|
| 11 | 3′6′-Bis[Phenyl (3-Methylphenyl) | Stearyl 4- | Pentadecane | Dodecanedioic | P- | Piccolastic |
| | Amino]-Spiro [isobensofuran-1(3H),9′- | hydroxybenzoate | (26.5) | acid | terphenyl | A-5 |
| | [9H]xanthene]-3-on | (10.0) | | (1.0) | (1.0) | (3.5) |
| | (1.0) | | | | | |
| 12 | 3′6′-Bis[Phenyl (3-Methylphenyl) | Stearyl 4- | Pentadecane | Dodecanedioic | P- | Piccolastic |
| | Amino]-Spiro [isobensofuran-1(3H),9′- | hydroxybenzoate | (23.0) | acid | terphenyl | A-5 |
| | [9H]xanthene]-3-on | (10.0) | | (1.0) | (1.0) | (7.0) |
| | (1.0) | | | | | |
| 13 | 3′6′-Bis[Phenyl (3-Methylphenyl) | Stearyl 4- | Pentadecane | Dodecanedioic | P- | Piccolastic |
| | Amino]-Spiro [isobensofuran-1(3H),9′- | hydroxybenzoate | (16.0) | acid | terphenyl | A-5 |
| | [9H]xanthene]-3-on | (10.0) | | (1.0) | (1.0) | (14.0) |
| | (1.0) | | | | | |
| 14 | 3′6′-Bis[Phenyl (3-Methylphenyl) | Stearyl 4- | Pentadecane | Dodecanedioic | P- | Piccolastic |
| | Amino]-Spiro [isobensofuran-1(3H),9′- | hydroxybenzoate | (23.0) | acid | terphenyl | A-75 |
| | [9H]xanthene]-3-on | (10.0) | | (1.0) | (1.0) | (7.0) |
| | (1.0) | | | | | |
| 15 | 3′6′-Bis[Phenyl (3-Methylphenyl) | Stearyl 4- | Pentadecane | Dodecanedioic | P- | Kristalex |
| | Amino]-Spiro [isobensofuran-1(3H),9′- | hydroxybenzoate | (23.0) | acid | terphenyl | 3085 |
| | [9H]xanthene]-3-on | (10.0) | | (1.0) | (1.0) | (7.0) |
| | (1.0) | | | | | |
| 16 | 2-(dibutylamino)-8-(diphenylamino)-4- | Stearyl 4- | Pentadecane | Eicosanedioic | P- | Piccolastic |
| | methylspiro[5H-[1]benzopyrano[2,3- | hydroxybenzoate | (23.0) | acid | terphenyl | A-5 |
| | d]pyrimidine-5,1′(3′H)-isobenzofuran]- | (10.0) | | (1.0) | (1.0) | (7.0) |
| | 3′-on | | | | | |
| | (1.0) | | | | | |
| 17 | 2-(dibutylamino)-8-(diphenylamino)-4- | Stearyl 4- | Pentadecane | Eicosanedioic | P- | Piccolastic |
| | methylspiro[5H-[1]benzopyrano[2,3- | hydroxybenzoate | (23.0) | acid | terphenyl | A-75 |
| | d]pyrimidine-5,1′(3′H)-isobenzofuran]- | (10.0) | | (1.0) | (1.0) | (7.0) |
| | 3′-on | | | | | |
| | (1.0) | | | | | |
| 18 | 2-(dibutylamino)-8-(diphenylamino)-4- | Stearyl 4- | Pentadecane | Eicosanedioic | P- | Piccotex |
| | methylspiro[5H-[1]benzopyrano[2,3- | hydroxybenzoate | (23.0) | acid | terphenyl | 120 |
| | d]pyrimidine-5,1′(3′H)-isobenzofuran]- | (10.0) | | (1.0) | (1.0) | (7.0) |
| | 3′-on | | | | | |
| | (1.0) | | | | | |
| 19 | 2-(dibutylamino)-8-(diphenylamino)-4- | Stearyl 4- | Pentadecane | Eicosanedioic | P- | Piccolyte |
| | methylspiro[5H-[1]benzopyrano[2,3- | hydroxybenzoate | (23.0) | acid | terphenyl | S115 |
| | d]pyrimidine-5,1′(3′H)-isobenzofuran]- | (10.0) | | (1.0) | (1.0) | (7.0) |
| | 3′-on | | | | | |
| | (1.0) | | | | | |
| 20 | 3′6′-Bis[Phenyl (3-Methylphenyl) | Stearyl 4- | Pentadecane | Dodecanedioic | P- | Kristalex |
| | Amino]-Spiro [isobensofuran-1(3H),9′- | hydroxybenzoate | (23.0) | acid | terphenyl | 3100 |
| | [9H]xanthene]-3-on | (10.0) | | (1.0) | (1.0) | (7.0) |
| | (1.0) | | | | | |

Each reversibly thermochromic composition was heated and melted to form a phase solution, a solution obtained by mixing 30.0 parts of an aromatic isocyanate prepolymer as a wall film material and 40.0 parts of a co-solvent was then emulsified and dispersed in an 8% polyvinyl alcohol aqueous solution, stirring was continued while heating, 2.5 parts of a water-soluble aliphatically modified amnine was then added, and stirring was further continued to obtain a microcapsule suspension. The suspension was centrifuged to obtain a reversibly thermochromic microcapsule pigment (Examples 1 to 20).

For the reversibly thermochromic microcapsule pigment, the following measurement samples were prepared, and then the discoloration temperature was measured by the following measurement method.

### Measurement Sample

A printed matter printed on high-quality paper by screen printing using a reversibly thermochromic ink obtained by dispersing 40 parts of the reversibly thermochromic microcapsule pigment in 60 parts of an ethylene-vinyl acetate emulsion was used as a measurement sample.

### Measurement Method

A measurement sample prepared using each of the reversibly thermochromic microcapsule pigments of Examples 1 to 20 is set at a predetermined position of a color difference meter [TC-3600 color difference meter, manufactured by Tokyo Denshoku Co., Ltd.], and heated at a temperature width of 0° C. to 60° C. at a rate of 10° C./min.

The mixture was heated to 60° C., then cooled to a decoloring induction temperature, and left to decolor.

Separately from this, the sample was heated at a temperature range of 0° C. to 60° C. at a rate of 10° C./min and then left at 15° C. for 1 minute to measure the lightness value.

The color change, the color development starting temperature (T₁), the complete color development temperature (T₂), the lightness value at the complete color development temperature (T₂), the decoloring induction temperature, and the lightness value immediately after standing at 15° C. for 1 minute in each example are shown in the following table.

In the table, the smaller the lightness value, the higher the density, and the larger the brightness value, the lower the density.

TABLE 3

| | | Discoloration | | Lightness | | | |
|---|---|---|---|---|---|---|---|
| | | temperature (° C.) | | value | Decoloring induction | | Lightness value |
| Example | Color change | T₁ | T₂ | (T₂) | temperatureT₃ | | 15° C., 1 minute |
| 1 | Colorless ←→ Blue | 35° C. | 45° C. | 4.40 | 18° | C. | 7.96 |
| 2 | Colorless ←→ Blue | 36° C. | 48° C. | 4.55 | 26° | C. | 8.40 |
| 3 | Colorless ←→ Blue | 36° C. | 47° C. | 4.55 | 26° | C. | 8.40 |
| 4 | Colorless ←→ Blue | 36° C. | 47° C. | 4.55 | 26° | C. | 8.62 |
| 5 | Colorless ←→ Blue | 35° C. | 47° C. | 4.55 | 25° | C. | 8.18 |
| 6 | Colorless ←→ Blue | 38° C. | 48° C. | 4.55 | 26° | C. | 8.51 |
| 7 | Colorless ←→ Pink | 38° C. | 48° C. | 4.55 | 26° | C. | 8.62 |
| 8 | Colorless ←→ Blue | 35° C. | 50° C. | 4.44 | 25° | C. | 8.29 |
| 9 | Colorless ←→ Blue | 35° C. | 50° C. | 4.66 | 26° | C. | 8.18 |
| 10 | Colorless ←→ Blue | 45° C. | 57° C. | 4.88 | 33° | C. | 8.40 |
| 11 | Colorless ←→ Blue | 38° C. | 51° C. | 5.10 | 26.0° | C. | 8.60 |
| 12 | Colorless ←→ Blue | 42° C. | 53° C. | 5.10 | 28.0° | C. | 8.80 |
| 13 | Colorless ←→ Blue | 42° C. | 53° C. | 5.00 | 28.0° | C. | 8.80 |
| 14 | Colorless ←→ Blue | 42° C. | 53° C. | 5.10 | 28.0° | C. | 8.80 |
| 15 | Colorless ←→ Blue | 42° C. | 53° C. | 5.00 | 28.0° | C. | 8.80 |
| 16 | Colorless ←→ Pink | 36° C. | 51° C. | 6.80 | 27.0° | C. | 8.51 |
| 17 | Colorless ←→ Pink | 38° C. | 52° C. | 6.90 | 27.0° | C. | 8.40 |
| 18 | Colorless ←→ Pink | 36° C. | 53° C. | 6.80 | 28.0° | C. | 8.90 |
| 19 | Colorless ←→ Pink | 37° C. | 51° C. | 6.80 | 27.0° | C. | 8.80 |
| 20 | Colorless ←→ Blue | 38° C. | 52° C. | 5.00 | 27.0° | C. | 8.80 |

### Comparative Examples 1 to 4

The composition used in the reversibly thermochromic composition is shown in the following table.

The numbers in ( ) in the table indicate parts by mass, and the numbers indicating the blending amounts shown below are all parts by mass.

TABLE 4

| | | | | | | |
|---|---|---|---|---|---|---|
| Comparative | | | | | | |
| Example | (A) | (B) | (C) | (D) | (E) | (F) |

| | | | | |
|---|---|---|---|---|
| 1 | 3′6′-Bis[Phenyl (3-Methylphenyl) | Cetyl 4- | Pentadecane | P-terphenyl |
| | Amino]-Spiro [isobensofuran- | hydroxybenzoate | (30.0) | (1.0) |
| | 1(3H),9′-[9H]xanthene]-3-on | (10.0) | | |
| | (1.0) | | | |
| 2 | 3′6′-Bis[Phenyl (3-Methylphenyl) | Stearyl 4- | Pentadecane | P-terphenyl |
| | Amino]-Spiro [isobensofuran- | hydroxybenzoate | (30.0) | (1.0) |
| | 1(3H),9′-[9H]xanthene]-3-on | (10.0) | | |
| | (1.0) | | | |
| 3 | 3′6′-Bis[Phenyl (3-Methylphenyl) | Arachidyl 4- | Pentadecane | P-terphenyl |
| | Amino]-Spiro [isobensofuran- | hydroxybenzoate | (30.0) | (1.0) |
| | 1(3H),9′-[9H]xanthene]-3-on | (10.0) | | |
| | (1.0) | | | |
| 4 | 2-(dibutylamino)-8- | Stearyl 4- | Pentadecane | P-terphenyl |
| | (diphenylamino)-4-methylspiro[5H- | hydroxybenzoate | (30.0) | (1.0) |
| | [1]benzopyrano[2,3-d]pyrimidine- | (10.0) | | |
| | 5,1′(3′H)-isobenzofuran]-3′-on | | | |
| | (1.0) | | | |

Each reversibly thermochromic composition was heated and melted to form a phase solution, a solution obtained by mixing 30.0 parts of an aromatic isocyanate prepolymer as a wall film material and 40.0 parts of a co-solvent was then emulsified and dispersed in an 8% polyvinyl alcohol aqueous solution, stirring was continued while heating, 2.5 parts of a water-soluble aliphatically modified amine was then added, and stirring was further continued to obtain a microcapsule suspension. The suspension was centrifuged to obtain a reversibly thermochromic microcapsule pigment (Comparative Examples 1 to 4).

For the reversibly thermochromic microcapsule pigment, the following measurement samples were prepared, and then the discoloration temperature was measured by the following measurement method.

### Measurement Sample

A printed matter printed on high-quality paper by screen printing using a reversibly thermochromic ink obtained by dispersing 40 parts of the reversibly thermochromic microcapsule pigment in 60 parts of an ethylene-vinyl acetate emulsion was used as a measurement sample.

### Measurement Method

A measurement sample prepared using each of the reversibly thermochromic microcapsule pigments of Comparative Examples 1 to 4 is set at a predetermined position of a color difference meter [TC-3600 color difference meter, manufactured by Tokyo Denshoku Co., Ltd.], and heated at a temperature width of 0° C. to 60° C. at a rate of 10° C./min.

The mixture was heated to 60° C., then cooled to a decoloring induction temperature, and left to decolor.

Separately from this, the sample was heated at a temperature range of 0° C. to 60° C. at a rate of 10° C./min and then left at 15° C. for 1 minute to measure the lightness value.

The color change, the color development starting temperature (T₁), the complete color development temperature (T₂), the lightness value at the complete color development temperature (T₂), the decoloring induction temperature, and the lightness value immediately after standing at 15° C. for 1 minute in each comparative example are shown in the following table.

TABLE 5

| | | | | | Decoloring | |
|---|---|---|---|---|---|---|
| | | Discoloration | | Lightness | induction | |
| Comparative | | temperature (° C.) | | value | temperature | Lightness value |
| Example | Color change | T₁ | T₂ | (T₂) | T₃ | 15° C., 1 minute |
| 1 | Colorless ←→ Blue | 32° C. | 45° C. | 4.40 | 18° C. | 7.30 |
| 2 | Colorless ←→ Blue | 38° C. | 52° C. | 4.66 | 27° C. | 7.85 |
| 3 | Colorless ←→ Blue | 45° C. | 58° C. | 4.66 | 38° C. | 8.18 |
| 4 | Colorless ←→ Pink | 38° C. | 53° C. | 6.90 | 28° C. | 8.10 |

### Application Example 1

30.0 parts of the microcapsule pigment containing the reversibly thermochromic composition prepared in Example 1 was mixed in a vehicle composed of 45.0 parts of an acrylic acid ester resin emulsion, 1.0 parts of an antifoaming agent and 23.0 parts of diluted water, and the mixture was filtered through a 180 mesh screen to obtain a reversibly thermochromic spray coating material.

The spray coating material was filled in a spray gun (diameter: 0.6 mm) to coat the entire surface of a white fabric (support), and then dried to form a reversibly thermochromic layer, thereby obtaining a reversibly thermochromic fabric.

The fabric was sewn to prepare a swimsuit.

The swimsuit showed blue when heated to 45° C. or higher.

When the swimsuit was cooled to 18° C. and then left, the swimsuit showed white color.

### Application Example 2

A reversibly thermochromic screen ink containing 30.0 parts of the microcapsule pigment encapsulating the reversibly thermochromic composition prepared in Example 2, 2.0 parts of a fluorescent pigment (pink), 50.0 parts of an acrylic resin emulsion, 3.0 parts of an antifoaming agent, and 15.0 parts of a turpentine emulsion was prepared.

Printing was performed on a polyester taffeta by screen printing using the reversibly thermochromic screen ink to form a reversibly thermochromic layer, thereby obtaining a reversibly thermochromic sheet.

The reversibly thermochromic sheet exhibited a purple color when heated to 48° C. or higher.

When the reversibly thermochromic sheet was cooled to 26° C. and then left to stand, the reversibly thermochromic sheet showed pink.

### Application Example 3

50.0 parts of the microcapsule pigment containing the reversibly thermochromic composition prepared in Example 3 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

The sheet showed blue when heated to 47° C. or higher.

When the reversibly thermochromic sheet was cooled to 26° C. and then left to stand, the reversibly thermochromic sheet became colorless.

### Application Example 4

20.0 parts of an aliphatic polyamide curable at room temperature was added to a reversibly thermochromic epoxy ink obtained by uniformly dispersing and kneading 33.3 parts of a microcapsule pigment containing the reversibly thermochromic composition prepared in Example 4, 66.4 parts of a hard type liquid epoxy resin, and 0.3 parts of an antifoaming agent, and the mixture was stirred and mixed to prepare a reversibly thermochromic epoxy ink.

Curved screen printing was performed on the surface of the ceramic cup with a stainless steel 100 mesh screen plate using the reversibly thermochromic epoxy ink, and heating and curing was performed at 70° C. for 60 minutes to form a reversibly thermochromic layer, thereby obtaining a reversibly thermochromic cup.

The reversibly thermochromic cup exhibited blue when heated to 47° C. or higher.

When the reversibly thermochromic cup was cooled to 26° C. and then left to stand, the reversibly thermochromic cup became colorless.

### Application Example 5

A reversibly thermochromic spray coating material was prepared by stirring and mixing in a vehicle composed of 10.0 parts of a microcapsule pigment encapsulating the reversibly thermochromic composition prepared in Example 5, 1.0 parts of a fluorescent pigment (pink), 45.0 parts of a 50% acrylic resin/xylene solution, 15.0 parts of xylene, 23.0 parts of methyl isobutyl ketone, and 6.0 parts of a polyisocyanate-based curing agent.

The reversibly thermochromic spray coating material was spray-coated on the entire miniature train to form a reversibly thermochromic layer, thereby obtaining a reversibly thermochromic miniature train.

The reversibly thermochromic miniature train showed a purple color when heated to 47° C. or higher.

When the reversibly thermochromic miniature train was cooled to 25° C. and then left, the reversibly thermochromic miniature train turned pink.

### Application Example 6

50.0 parts of the microcapsule pigment encapsulating the reversibly thermochromic composition prepared in Example 6, 0.04 parts of a yellow pigment, 1000.0 parts of a 12 nylon resin (melting point: 178° C.), and 10.0 parts of an ultraviolet absorber were mixed and dispersed with a Henschel mixer, and then a reversibly thermochromic 12 nylon resin pellet (reversibly thermochromic composition) was obtained using an extrusion molding machine.

Melt-spinning was performed using the reversible thermochromic molding resin composition to obtain a reversibly thermochromic filament as a molded body.

The filament was used to graft the puppet's head.

When the filament was heated to 48° C. or higher, the filament showed green in which blue and yellow were mixed.

When the filament was cooled to 26° C. and then left, the filament showed yellow.

### Application Example 7

A reversibly thermochromic spray coating material was prepared by stirring and mixing in a vehicle composed of 10.0 parts of a microcapsule pigment encapsulating the reversibly thermochromic composition prepared in Example 7, 1.0 parts of a blue pigment, 45.0 parts of a 50% acrylic resin/xylene solution, 15.0 parts of xylene, 23.0 parts of methyl isobutyl ketone, and 6.0 parts of a polyisocyanate-based curing agent.

The reversibly thermochromic spray coating material was spray-coated on the entire miniature train to form a reversibly thermochromic layer, thereby obtaining a reversibly thermochromic miniature car.

The reversibly thermochromic miniature car showed a purple color when heated to 48° C. or higher.

When the reversibly thermochromic miniature car was cooled to 26° C. and then left, the reversibly thermochromic miniature car turned blue.

### Application Example 8

50.0 parts of the microcapsule pigment containing the reversibly thermochromic composition prepared in Example 8 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

Frictional heat was generated by rubbing on the sheet using a friction tool manufactured by SEBS, and blue was exhibited when the sheet was heated to 50° C. or higher.

When the reversibly thermochromic sheet was cooled to 25° C. and then left to stand, the reversibly thermochromic sheet became white.

### Application Example 9

50.0 parts of the microcapsule pigment containing the reversibly thermochromic composition prepared in Example 10 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

When the sheet was heated to 57° C. or higher from above using an energization heater, blue was exhibited.

When the reversibly thermochromic sheet was cooled to 33° C. and then left for a while, the reversibly thermochromic sheet showed a white.

### Application Example 10

50.0 parts of the microcapsule pigment containing the reversibly thermochromic composition prepared in Example 12 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

Frictional heat was generated by rubbing on the sheet using a friction tool manufactured by SEBS, and blue was exhibited when the sheet was heated to 53° C. or higher.

When the reversibly thermochromic sheet was cooled to 28° C. and then left to stand, the reversibly thermochromic sheet became white.

### Application Example 13

50.0 parts of the microcapsule pigment containing the reversibly thermochromic composition prepared in Example 16 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

Frictional heat was generated by rubbing on the sheet using a friction tool manufactured by SEBS, and pink was exhibited when the sheet was heated to 51° C. or higher.

When the reversibly thermochromic sheet was cooled to 27° C. and then left to stand, the reversibly thermochromic sheet became white.

### Application Example 14

50.0 parts of the microcapsule pigment containing the reversibly thermochromic composition prepared in Example 17 was uniformly dispersed and mixed in 50.0 parts of a linseed oil-based offset ink vehicle to prepare a reversibly thermochromic offset ink.

Offset printing was performed on high-quality paper using the offset ink to form a reversibly thermochromic layer, thereby obtaining a reversibly thermochromic sheet.

Frictional heat was generated by rubbing on the sheet using a friction tool manufactured by SEBS, and pink was exhibited when the sheet was heated to 52° C. or higher.

When the reversibly thermochromic sheet was cooled to 27° C. and then left to stand, the reversibly thermochromic sheet became white.

1. A reversibly thermochromic microcapsule pigment in which a reversibly thermochromic composition that turns into a color developed state by heating from a decolored state and turns into a decolored state by lowering a temperature from a color developed state is encapsulated in a microcapsule, the pigment comprising:
(A) an electron-donating color-developing organic compound;
(B) a 4-hydroxybenzoic acid ester compound represented by General Formula (1) below as an electron-accepting compound;
(C) a compound selected from the group consisting of chain hydrocarbons, alicyclic hydrocarbons, and halogenated hydrocarbons as a reaction medium that reversibly induces an electron transfer reaction according to (A) and (B);
(D) a linear dibasic acid compound having 3 to 22 carbon atoms; and
(E) a compound selected from the group consisting of alcohols, esters, ethers, ketones, acid amides, and aromatic hydrocarbons having a melting point of 50° C. or higher, 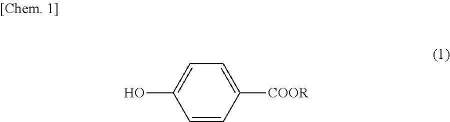
wherein R represents a linear or branched chain alkyl group having 12 to 22 carbon atoms.

2. The reversibly thermochromic microcapsule pigment according to claim 1,
wherein R in General Formula (1) is a linear chain alkyl group having 14 to 22 carbon atoms.

3. The reversibly thermochromic microcapsule pigment according to claim 1, wherein a ratio of the component (D) to the component (A) is 0.1 to 1% by mass.

4. The reversibly thermochromic microcapsule pigment according to claim 1, wherein a ratio of the component (E) to the component (A) is 0.3 to 2% by mass.

5. The reversibly thermochromic microcapsule pigment according to claim 1, further comprising (F) an oligomer selected from a styrene-based oligomer having a weight average molecular weight of 200 to 6000, a terpene-based oligomer having a weight average molecular weight of 250 to 4000, or a terpene phenol-based oligomer having a weight average molecular weight of 200 to 2000.

6. The reversibly thermochromic microcapsule pigment according to claim 5, wherein a mass ratio of the component (D) to the component (F) is 1.0:3.5 to 1.0:30.0.

7. The reversibly thermochromic microcapsule pigment according to claim 2, wherein a ratio of the component (D) to the component (A) is 0.1 to 1% by mass.

8. The reversibly thermochromic microcapsule pigment according to claim 2, wherein a ratio of the component (E) to the component (A) is 0.3 to 2% by mass.

9. The reversibly thermochromic microcapsule pigment according to claim 2, further comprising (F) an oligomer selected from a styrene-based oligomer having a weight average molecular weight of 200 to 6000, a terpene-based oligomer having a weight average molecular weight of 250 to 4000, or a terpene phenol-based oligomer having a weight average molecular weight of 200 to 2000.

10. The reversibly thermochromic microcapsule pigment according to claim 9, wherein a mass ratio of the component (D) to the component (F) is 1.0:3.5 to 1.0:30.0.
